(19) United States
(12) Patent Application Publication
(10) Pub. No.: US 2024/0254635 A1
(43) Pub. Date: Aug. 1, 2024

(54) AMMONIA GENERATOR USING PLASMA

(71) Applicant: KOREA INSTITUTE OF MACHINERY & MATERIALS, Daejeon (KR)

(72) Inventors: You-Na KIM, Daejeon (KR); Dae-hoon LEE, Daejeon (KR); Younghoon SONG, Daejeon (KR); Kwan-Tae KIM, Daejeon (KR); Hong Jae KANG, Daejeon (KR); Hohyun SONG, Daejeon (KR); Heesoo LEE, Daejeon (KR)

(21) Appl. No.: 18/561,021

(22) PCT Filed: Jun. 23, 2022
(86) PCT No.: PCT/KR2022/008985

§ 371 Date: Nov. 15, 2023

(30) Foreign Application Priority Data
Jun. 23, 2021 (KR) 10-2021-0081766
Jun. 16, 2022 (KR) 10-2022-0073586

(51) Int. Cl. C25B 1/27; C01B 21/20; C25B 15/08

(52) U.S. Cl. CPC C25B 1/27; C01B 21/203; C25B 15/08

(57) ABSTRACT

An ammonia generator using plasma according to an embodiment of the present invention includes a plasma reactor that generates a plasma discharge using nitrogen (N₂) as a discharge gas, generates hydrogen (H₂) and oxygen (O₂) from water (H₂O) using energy of the plasma, generates nitrogen monoxide (NO) from the oxygen (O₂) and the nitrogen (N₂), and supplies the hydrogen (H₂) and the nitrogen monoxide (NO), a first reactor that generates ammonia (NH₃) by first action on the nitrogen (N₂), the nitrogen monoxide (NO), and the hydrogen (H₂) supplied from the plasma reactor, and a second reactor that additionally generates the ammonia (NH₃) by second action on a nitrate solution (NO₃⁻) generated in the plasma reactor.

### TECHNICAL FIELD

The present invention relates to an ammonia generator using plasma, and more particularly, to an ammonia generator using plasma that generates ammonia using nitrogen oxides (NOx) generated by a plasma reaction.

### BACKGROUND ART

Ammonia is a key material required for agriculture and green energy storage. In the case of the Haber-Bosch process, which accounts for 90% or more of a current ammonia production process, conditions of high temperature of 350 to 550° C. and high pressure of 150 to 350 bar are required, which accounts for about 1.2% of global energy consumption. A hydrogen production process required to generate ammonia accounts for 1.6% of global carbon dioxide emissions. Therefore, development and commercialization of an ammonia production process with low fuel consumption and carbon dioxide emission are required.

### DISCLOSURE

### Technical Problem

The present disclosure attempts to provide an ammonia generator using plasma that generates nitrogen oxides (NOx) through water (or oxygen or oxygen-containing air) and nitrogen using plasma reactor and generates ammonia using the nitrogen oxides (NOx).

The present disclosure attempts to provide an ammonia generator using plasma that further generates ammonia by treating a nitrate solution (NO₃⁻) generated in a plasma reaction.

### Technical Solution

According to an embodiment, an ammonia generator using plasma includes a plasma reactor that generates a plasma discharge using nitrogen (N₂) as a discharge gas, generates hydrogen (H₂) and oxygen (O₂) from water (H₂O) using energy of the plasma, generates nitrogen monoxide (NO) from the oxygen (O₂) and the nitrogen (N₂), and supplies the hydrogen (H₂) and the nitrogen monoxide (NO), a first reactor that generates ammonia (NH₃) by first action on the nitrogen (N₂), the nitrogen monoxide (NO), and the hydrogen (H₂) supplied from the plasma reactor, and a second reactor that additionally generates the ammonia (NH₃) by second action on a nitrate solution (NO₃⁻) generated in the plasma reactor.

The first reactor may be formed as a catalytic reactor that generates ammonia by catalyzing the nitrogen (N₂), the nitrogen monoxide (NO), and the hydrogen (H₂).

The second reactor may be formed as an electrochemical cell that additionally directly generates the ammonia (NH₃) by electrochemical action on a nitrate solution (NO₃⁻).

The catalytic reactor may be connected to an additional hydrogen line to generate the ammonia (NH₃), including additionally introduced hydrogen (H₂).

The plasma reactor and the catalytic reactor may be connected to a heat recovery line to heat water (H₂O) with heat recovered at each discharge side.

The plasma reactor may be connected to an air separator that separates nitrogen from air and supplies the nitrogen.

The second reactor may be formed as an adsorption catalytic reactor that additionally directly generates the ammonia (NH₃) and the nitrogen (N₂) by adsorption catalytic reduction action on the nitrate solution (NO₃⁻) and the input hydrogen (H₂).

According to an embodiment, an ammonia generator using plasma includes a plasma reactor that generates a plasma discharge using air as a discharge gas and generates and supplies nitrogen (N₂), nitrogen monoxide (NO), and nitrogen dioxide (NO₂) from the air using energy of the plasma, a first reactor that generates dinitrogen pentoxide (N₂O₅) with additional oxidation by supplying ozone (O₃) generated from the air to the nitrogen monoxide (NO) and the nitrogen dioxide (NO₂) supplied from the plasma reactor, and a second reactor that acts on the nitrogen (N₂) and the dinitrogen pentoxide (N₂O₅) generated by the first reactor, and acts on a nitrate solution (NO₃⁻) generated by supplying water (H₂O) to the nitrogen (N₂) and the dinitrogen pentoxide (N₂O₅) to generate ammonia (NH₃) and the nitrogen (N₂).

The first reactor may be formed as an ozone generator.

The second reactor may be formed as an electrochemical cell that generates the ammonia (NH₃) by electrochemical action on the nitrogen (N₂), the dinitrogen pentoxide (N₂O₅), and the nitrate solution (NO₃⁻).

The plasma reactor may be connected to a heat recovery line to heat the air with heat recovered at each discharge side.

According to an embodiment, an ammonia generator using plasma includes a plasma reactor that generates a plasma discharge using air as a discharge gas and generates and supplies nitrogen (N₂), nitrogen monoxide (NO), nitrogen dioxide (NO₂), and oxygen (O₂) from the air using energy of the plasma, a first reactor that removes the oxygen (O₂) supplied from the plasma reactor, and a second reactor that generates ammonia (NH₃) and the nitrogen (N₂) by acting on the nitrogen (N₂), the nitrogen monoxide (NO), and the nitrogen dioxide (NO₂) passing through the first reactor.

The first reactor may be formed as an oxygen separator that separates oxygen from the generated nitrogen (N₂), nitrogen monoxide (NO), nitrogen dioxide (NO₂), and oxygen (O₂).

The second reactor may be formed as an electrochemical cell that generates the ammonia (NH₃) and the nitrogen (N₂) by electrochemical action on the nitrogen (N₂), the nitrogen monoxide (NO), and the nitrogen dioxide (NO₂).

The second reactor may be formed as an adsorption catalytic reactor that generates the ammonia (NH₃) and the nitrogen (N₂) by adsorption catalytic reduction action on the nitrogen (N₂), the nitrogen monoxide (NO), and the nitrogen dioxide (NO₂).

### Advantageous Effects

According to an embodiment of the present invention, it is possible to generate ammonia (NH₃) in a first reactor from nitrogen monoxide (NO), hydrogen (H₂), and nitrogen (N₂) generated in a plasma reactor using water and nitrogen, and additionally generate ammonia (NH₃) in a second reactor with a nitrate solution (NO₃⁻) generated in the plasma reactor.

According to another embodiment of the present invention, it is possible to generate dinitrogen pentoxide (N₂O₅) with additional oxidation by supplying ozone (O₃) generated in a first reactor to nitrogen monoxide (NO), nitrogen dioxide (NO₂), and nitrogen (N₂) generated in a plasma reactor using air, generate ammonia (NH₃) in a second reactor from the dinitrogen pentoxide (N₂O₅) and nitrogen (N₂), and further generate ammonia (NH₃) in the second reactor with a nitrate solution (NO₃⁻) generated by supplying water (H₂O) to dinitrogen pentoxide (N₂O₅).

According to still another embodiment of the present invention, it is possible to remove oxygen (O₂) from nitrogen monoxide (NO), nitrogen dioxide (NO₂), nitrogen (N₂), and oxygen (O₂) generated in a plasma reactor using air with the first reactor, and generate ammonia (NH₃) and nitrogen (N₂) in a second reactor from nitrogen (N₂), nitrogen monoxide (NO), and nitrogen dioxide (NO₂).

### DESCRIPTION OF THE DRAWINGS

FIG. 1 is a configuration diagram of an ammonia generator using plasma according to a first embodiment of the present invention.

FIG. 2 is a configuration diagram of an ammonia generator using plasma according to a second embodiment of the present invention.

FIG. 3 is a configuration diagram of an ammonia generator using plasma according to a third embodiment of the present invention.

FIG. 4 is a configuration diagram of an ammonia generator using plasma according to a fourth embodiment of the present invention.

FIG. 5 is a configuration diagram of an ammonia generator using plasma according to a fifth embodiment of the present invention.

### MODE FOR INVENTION

Hereinafter, the present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

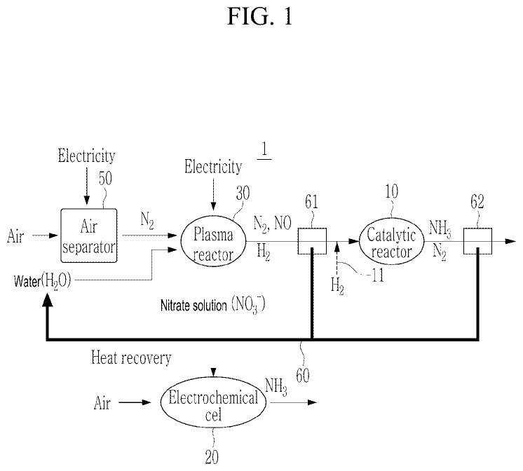

FIG. 1 is a configuration diagram of an ammonia generator using plasma according to a first embodiment of the present invention. Referring to FIG. 1, an ammonia generator 1 of a first embodiment includes a plasma reactor 30, a first reactor 10, and a second reactor 20. As an example, the first reactor 10 is formed as a catalytic reactor, and the second reactor 20 is formed as an electrochemical cell.

The plasma reactor 30 uses nitrogen (N₂) as a discharge gas and generates nitrogen oxides (NOx) and hydrogen (H₂) from supplied water (H₂O). In the first embodiment, the plasma reactor 30 generates and supplies nitrogen (N₂), nitrogen monoxide (NO), and hydrogen (H₂) using nitrogen and water. Oxygen or air may be supplied instead of water. The plasma reactor 30 may adjust production rates of nitrogen (N₂), nitrogen monoxide (NO), and hydrogen (H₂) according to discharge conditions. Therefore, hydrogen may be additionally input.

The plasma reactor 30 may be connected to an air separator 50. The air separator 50 may separate nitrogen from air and supply nitrogen to the plasma reactor 30. As an example, the air separator 50 separates nitrogen from air by pressure swing adsorption (PAS).

The first reactor 10 first acts on nitrogen (N₂), nitrogen monoxide (NO), and hydrogen (H₂) supplied from the plasma reactor 30 to generate ammonia (NH₃). As an example, the first reactor 10 may be formed as a catalytic reactor. The first reactor 10 generates ammonia by catalyzing nitrogen (N₂), nitrogen monoxide (NO), and hydrogen (H₂). The catalytic reactor enables the generation of ammonia through a highly efficient and eco-friendly process.

In this case, a high-concentration nitrate solution (NO₃⁻) may be generated in the plasma reactor 30. That is, nitrogen monoxide (NO) generated through the plasma reaction may be dissolved in water through an additional oxidation reaction and exist in a nitrate (NO₃⁻) ion state.

The second reactor 20 additionally generates ammonia (NH₃) by second action on the nitrate solution (NO₃⁻) generated in the plasma reactor 30. As an example, the second reactor 20 may be formed as an electrochemical cell. The second reactor 20 additionally directly generates ammonia (NH₃) by electrochemical action on the nitrate solution (NO₃⁻). The electrochemical cell enables the generation of the ammonia (NH₃) through a highly efficient and eco-friendly process.

The first reactor 10, that is, the catalytic reactor, may be connected to the additional hydrogen line 11. The additional hydrogen line 11 additionally inputs hydrogen (H₂) into the first reactor 10 to generate ammonia (NH₃). The first reactor 10 may discharge nitrogen not used for generating ammonia while generating ammonia through catalytic action. The additionally supplied hydrogen (H₂) enables additional generation of ammonia (NH₃) by the additional hydrogen line 11.

In addition, the ammonia generator 1 of the first embodiment may further include a first heat exchanger 61, a second heat exchanger 62, and a heat recovery line 60 to heat water (H₂O) supplied to the plasma reactor 30. The first heat exchanger 61 is provided on an outlet side of the plasma reactor 30, and the second heat exchanger 62 is provided on an outlet side of the first reactor 10.

The heat recovery line 60 heats water with the heat recovered through the first heat exchanger 61 on the discharge side of the plasma reactor 30, and heats water (H₂O) with heat recovered through the second heat exchanger 62 on the discharge side of the first reactor 10, that is, the catalytic reactor. The high-temperature water heated by the recovered heat does not interfere with the plasma reaction in the plasma reactor 30, so the generation efficiency of nitrogen (N₂), nitrogen monoxide (NO), and hydrogen (H₂) increases. As a result, the generation efficiency of ammonia (NH₃) finally increases.

Hereinafter, various embodiments of the present invention will be described. A description for the same components as those of the first exemplary embodiment and the exemplary embodiment described above will be omitted, and components different from those of the first exemplary embodiment and the exemplary embodiment described above will be described.

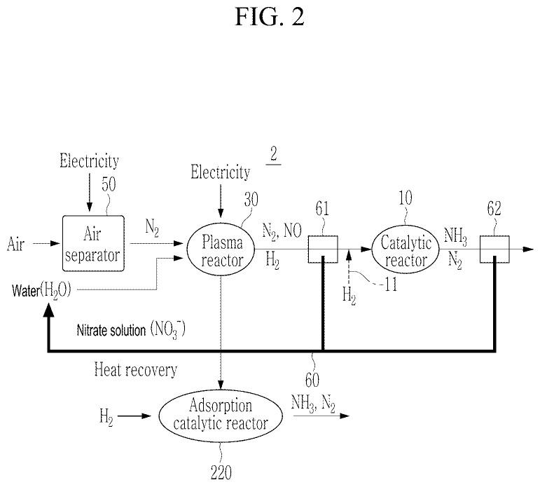

FIG. 2 is a configuration diagram of an ammonia generator using plasma according to a second embodiment of the present invention. Referring to FIG. 2, in the ammonia generator 2 of the second embodiment, a second reactor 220 is formed as an adsorption catalytic reactor. The second reactor 220 additionally directly generates ammonia (NH₃) and nitrogen (N₂) by adsorption catalytic reduction action on the nitrate solution (NO₃⁻) and the input hydrogen (H₂). The adsorption catalytic reactor has a catalyst-supported adsorbent, and concentrates the nitrate solution (NO₃⁻) in the catalyst-supported adsorbent and then generates ammonia through a catalytic reduction reaction by the input hydrogen (H₂). The adsorption catalytic reactor enables the generation of ammonia (NH₃) through a highly efficient and eco-friendly process.

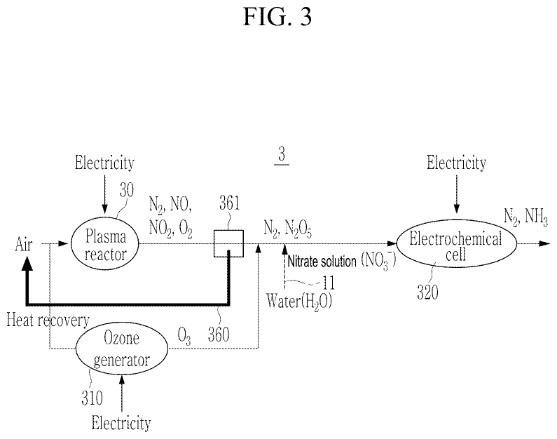

FIG. 3 is a configuration diagram of an ammonia generator using plasma according to a third embodiment of the present invention. Referring to FIG. 3, an ammonia generator 3 of a third embodiment includes a plasma reactor 30, a first reactor 310, and a second reactor 320.

The plasma reactor 30 generates nitrogen oxides (NOx), hydrogen (H₂), nitrogen (N₂), and oxygen (O₂) using air as a discharge gas. The plasma reactor 30 generates a plasma discharge and generates a nitrogen compound (NOx) from air using plasma energy. That is, nitrogen monoxide (NO) and nitrogen dioxide (NO₂) are generated.

As an example, the first reactor 310 may be formed as an ozone generator or a dielectric barrier discharge (DBD) plasma reactor. The first reactor 310 generates dinitrogen pentoxide (N₂O₅) with additional oxidation by supplying ozone (O₃) generated from air to nitrogen monoxide (NO) and nitrogen dioxide (NO₂) supplied from the plasma reactor 30. Accordingly, nitrogen (N₂) and dinitrogen pentoxide (N₂O₅) generated by the first reactor 310 may be supplied to the second reactor 320 to be described later.

As an example, the second reactor 320 may be formed as an electrochemical cell. The second reactor 320 acts on nitrogen (N₂) and dinitrogen pentoxide (N₂O₅) generated by the first reactor 310, and acts on a nitrate solution (NO₃⁻) generated by supplying water (H₂O) to nitrogen (N₂) and dinitrogen pentoxide (N₂O₅) to generate ammonia (NH₃) and nitrogen (N₂). That is, the second reactor 320 generates ammonia (NH₃) by electrochemical action on nitrogen (N₂) and the generated dinitrogen pentoxide (N₂O₅), and nitrate solution (NO₃−).

In addition, the ammonia generator 3 of the third embodiment further includes a heat exchanger 361 and a heat recovery line 360 to heat air supplied to the plasma reactor 30. The heat exchanger 361 is provided on the outlet side of the plasma reactor 30.

The heat recovery line 360 heats air with heat recovered through the heat exchanger 361 on the outlet side of the plasma reactor 30. The high-temperature air heated by the recovered heat does not interfere with the plasma reaction in the plasma reactor 30, so the generation efficiency of nitrogen (N₂), nitrogen monoxide (NO), nitrogen dioxide (NO₂), and oxygen (O₂) increases.

As a result, nitrogen (N₂), nitrogen monoxide (NO), nitrogen dioxide (NO₂), and oxygen (O₂) undergoes electrochemical action together with ozone (O₃) generated from air in the second reactor 320 to increase the generation efficiency of nitrogen (N₂) and dinitrogen pentoxide (N₂O₅). In addition, the nitrate solution (NO₃⁻) generated by supplying water (H₂O) undergoes electrochemical action in the second reactor 320 to finally increase the generation efficiency of ammonia (NH₃).

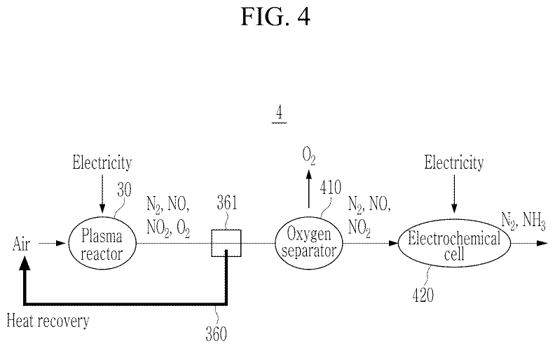

FIG. 4 is a configuration diagram of an ammonia generator using plasma according to a fourth embodiment of the present invention. Referring to FIG. 4, an ammonia generator 4 of a fourth embodiment includes a plasma reactor 30, a first reactor 410, and a second reactor 420.

The first reactor 410 removes oxygen (O₂) supplied from the plasma reactor 30. As an example, the first reactor 410 may be formed as an oxygen separator. The first reactor 410 separates and removes oxygen (O₂) from the generated nitrogen (N₂), nitrogen monoxide (NO), nitrogen dioxide (NO₂), and oxygen (O₂) into a vapor phase.

As an example, the second reactor 420 acts on nitrogen (N₂), nitrogen monoxide (NO), and nitrogen dioxide (NO₂) from which oxygen (O₂) is separated while passing through the first reactor 410 to generate ammonia (NH₃) and nitrogen (N₂). As an example, the second reactor 420 may be formed as an electrochemical cell. The second reactor 420 generates ammonia (NH₃) and nitrogen (N₂) by electrochemical action on nitrogen (N₂), nitrogen monoxide (NO), and nitrogen dioxide (NO₂). The electrochemical cell enables the generation of the ammonia (NH₃) through a highly efficient and eco-friendly process.

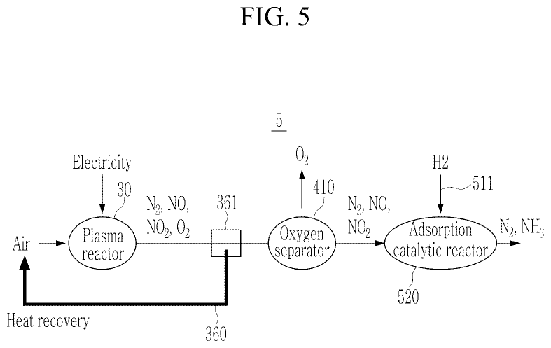

FIG. 5 is a configuration diagram of an ammonia generator using plasma according to a fifth embodiment of the present invention. Referring to FIG. 5, in the ammonia generator 5 of the fifth embodiment, a second reactor 520 may be formed as an adsorption catalytic reactor. The second reactor 520 directly generates ammonia (NH₃) and nitrogen (N₂) by adsorption catalytic reduction action on nitrogen (N₂), nitrogen monoxide (NO), and nitrogen dioxide (NO₂). The adsorption catalytic reactor enables the generation of ammonia (NH₃) through a highly efficient and eco-friendly process.

Meanwhile, the second reactor 520, that is, the adsorption catalytic reactor, may be connected to an additional hydrogen line 511. The additional hydrogen line 511 additionally inputs hydrogen (H₂) to the second reactor 520 to generate ammonia (NH₃). The second reactor 520 may discharge nitrogen not used for the generation of ammonia while generating ammonia by the adsorption catalytic action. The additionally supplied hydrogen (H₂) enables additional generation of ammonia (NH₃) by the additional hydrogen line 511.

The adsorption catalytic reactor has a catalyst-supported adsorbent, and absorbs nitrogen monoxide (NO) and nitrogen dioxide (NO₂) in the catalyst-supported adsorbent and then inputs hydrogen (H₂) to generate ammonia through the catalytic reduction reaction.

Although preferred embodiments of the present invention have been described above, the present invention is not limited thereto, and the present invention can be variously modified within the scope of the claims, the detailed description of the invention, and the appended drawings, and it is natural that various modifications also fall within the scope of the present invention.

(Description of reference numerals)

| | |
|---|---|
| 1, 2, 3, 4, 5: Ammonia generator | 30: Plasma reactor |
| 10, 310, 410, 510: First reactor | |
| 20, 220, 320, 420, 520: Second reactor | |
| 50: Air separator | 11, 511: Additional hydrogen |
| | line |
| 61: First heat exchanger | 62: Second heat exchanger |
| 60, 360: Heat recovery line | 361: Heat exchanger |

1. An ammonia generator using plasma, comprising:
a plasma reactor that generates a plasma discharge using nitrogen (N₂) as a discharge gas, generates hydrogen (H₂) and oxygen (O₂) from water (H₂O) using energy of the plasma, generates nitrogen monoxide (NO) from the oxygen (O₂) and the nitrogen (N₂), and supplies the hydrogen (H₂) and the nitrogen monoxide (NO);
a first reactor that generates ammonia (NH₃) by first action on the nitrogen (N₂), the nitrogen monoxide (NO), and the hydrogen (H₂) supplied from the plasma reactor; and
a second reactor that additionally generates the ammonia (NH₃) by second action on a nitrate solution (NO₃⁻) generated in the plasma reactor.

2. The ammonia generator using plasma of claim 1, wherein:
the first reactor
is formed as a catalytic reactor that generates ammonia by catalyzing the nitrogen (N₂), the nitrogen monoxide (NO), and the hydrogen (H₂).

3. The ammonia generator using plasma of claim 2, wherein:
the second reactor
is formed as an electrochemical cell that additionally directly generates the ammonia (NH₃) by electrochemical action on a nitrate solution (NO₃⁻).

4. The ammonia generator using plasma of claim 2, wherein:
the catalytic reactor
is connected to an additional hydrogen line to generate the ammonia (NH₃), including additionally introduced hydrogen (H₂).

5. The ammonia generator using plasma of claim 2, wherein:
the plasma reactor and the catalytic reactor
are connected to a heat recovery line to heat water (H₂O) with heat recovered at each discharge side.

6. The ammonia generator using plasma of claim 1, wherein:
the plasma reactor
is connected to an air separator that separates nitrogen from air and supplies the nitrogen.

7. The ammonia generator using plasma of claim 1, wherein:
the second reactor
is formed as an adsorption catalytic reactor that additionally directly generates the ammonia (NH₃) and the nitrogen (N₂) by adsorption catalytic reduction action on the nitrate solution (NO₃⁻) and the input hydrogen (H₂).

8. An ammonia generator using plasma, comprising:
a plasma reactor that generates a plasma discharge using air as a discharge gas and generates and supplies nitrogen (N₂), nitrogen monoxide (NO), and nitrogen dioxide (NO₂) from the air using energy of the plasma;
a first reactor that generates dinitrogen pentoxide (N₂O₅) with additional oxidation by supplying ozone (O₃) generated from the air to the nitrogen monoxide (NO) and the nitrogen dioxide (NO₂) supplied from the plasma reactor; and
a second reactor that acts on the nitrogen (N₂) and the dinitrogen pentoxide (N₂O₅) generated by the first reactor, and acts on a nitrate solution (NO₃⁻) generated by supplying water (H₂O) to the nitrogen (N₂) and the dinitrogen pentoxide (N₂O₅) to generate ammonia (NH₃) and the nitrogen (N₂).

9. The ammonia generator using plasma of claim 8, wherein:
the first reactor
is formed as an ozone generator.

10. The ammonia generator using plasma of claim 8, wherein:
the second reactor
is formed as an electrochemical cell that generates the ammonia (NH₃) by electrochemical action on the nitrogen (N₂), the dinitrogen pentoxide (N₂O₅), and the nitrate solution (NO₃⁻).

11. The ammonia generator using plasma of claim 8, wherein:
the plasma reactor
is connected to a heat recovery line to heat the air with heat recovered at each discharge side.

12. An ammonia generator using plasma, comprising:
a plasma reactor that generates a plasma discharge using air as a discharge gas and generates and supplies nitrogen (N₂), nitrogen monoxide (NO), nitrogen dioxide (NO₂), and oxygen (O₂) from the air using energy of the plasma;
a first reactor that removes the oxygen (O₂) supplied from the plasma reactor; and
a second reactor that generates ammonia (NH₃) and the nitrogen (N₂) by acting on the nitrogen (N₂), the nitrogen monoxide (NO), and the nitrogen dioxide (NO₂) passing through the first reactor.

13. The ammonia generator using plasma of claim 12, wherein:
the first reactor
is formed as an oxygen separator that separates oxygen from the generated nitrogen (N₂), nitrogen monoxide (NO), nitrogen dioxide (NO₂), and oxygen (O₂).

14. The ammonia generator using plasma of claim 12, wherein:
the second reactor
is formed as an electrochemical cell that generates the ammonia (NH₃) and the nitrogen (N₂) by electrochemical action on the nitrogen (N₂), the nitrogen monoxide (NO), and the nitrogen dioxide (NO₂).

15. The ammonia generator using plasma of claim 12, wherein:
the second reactor
is formed as an adsorption catalytic reactor that generates the ammonia (NH₃) and the nitrogen (N₂) by adsorption catalytic reduction action on the nitrogen (N₂), the nitrogen monoxide (NO), and the nitrogen dioxide (NO₂).
